(19) United States
(12) Patent Application Publication
(10) Pub. No.: US 2026/0298754 A1
(43) Pub. Date: Oct. 1, 2026

(54) METHOD FOR ASCERTAINING AT LEAST ONE PARAMETER AND METHOD FOR COMPENSATION

(71) Applicant: Robert Bosch GmbH, Stuttgart (DE)

(72) Inventors: Michael Klein, Tuebingen (DE); Paul Fehling, Tuebingen (DE)

(21) Appl. No.: 19/574,660

(22) Filed: Mar. 23, 2026

(30) Foreign Application Priority Data
Mar. 31, 2025 (DE) 10 2025 112 402.7

(51) Int. Cl. G01L 19/00; G01L 19/06

(52) U.S. Cl. CPC G01L 19/0092; G01L 19/0627

(57) ABSTRACT

A method for ascertaining at least one parameter of a protective mass of a pressure sensor configured to measure a fluid pressure. A method for compensating for an acceleration cross-sensitivity of the pressure sensor is also described.

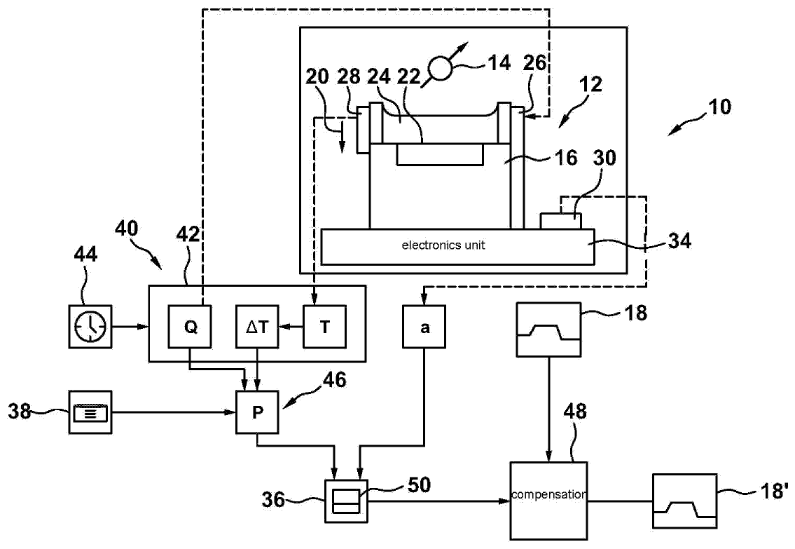

### CROSS REFERENCE

The present application claims the benefit under 35 U.S.C. § 119 of Germany Patent Application No. DE 10 2025 112 402.7 filed on Mar. 31, 2025, which is expressly incorporated herein by reference in its entirety.

### FIELD

The present disclosure relates to a method for ascertaining a parameter of at least one protective mass of a pressure sensor. Furthermore, the present disclosure relates to a method for compensating for an acceleration cross-sensitivity of the pressure sensor.

### BACKGROUND INFORMATION

Germany Patent Application No. DE 10 2004 033 956 A1 describes a method for the functional testing of a pressure sensor with a membrane, in which the deformation behavior of the membrane, i.e., the mechanical properties of the membrane essential for signal acquisition, is checked in a self-test. This generates a defined force acting on the membrane, which corresponds to a defined target signal from the functioning pressure sensor. An actual signal from the pressure sensor, caused by the defined force, is then evaluated, wherein the actual signal is compared with a target signal. In this way, deviations in the deformation behavior of the membrane are be detected.

### SUMMARY

According to the present disclosure, a method for ascertaining at least one parameter of a protective mass of a pressure sensor configured to measure a fluid pressure is provided. According to an example embodiment, the method includes:
providing the pressure sensor with: a sensor element that provides a measurement signal as a function of the fluid pressure and has an acceleration cross-sensitivity with respect to an acceleration acting on the pressure sensor, the protective mass applied to the sensor element to protect the sensor element from environmental influences, which protective mass affects the acceleration cross-sensitivity of the sensor element under the action of acceleration, a heating device for delivering thermal energy and a temperature-measuring element for measuring a temperature in the pressure sensor, wherein in a measurement operation the following is carried out:
inputting an amount of thermal energy at least into the protective mass by operating the heating device,
measuring, by the temperature-measuring element, at least one temperature measurement value of the temperature that changes due to the amount of thermal energy, and subsequently
calculating the parameter of the protective mass as a function of the amount of thermal energy and the temperature measurement value.

This allows the parameter to be ascertained more accurately, more quickly and more cost-effectively. The influence of the parameter on the measurement signal of the pressure sensor can be ascertained and compensated for more accurately, more quickly and more cost-effectively. The pressure sensor can measure fluid pressure more accurately and more reliably, yet still be designed to be cost-effective and space-saving.

According to an example embodiment, the pressure sensor can be a microelectromechanical (MEMS) pressure sensor. The pressure sensor can be usable in a vehicle, an aircraft, a watercraft, an industrial product, a healthcare product, a medical device and/or a consumer end product. The consumer end product can be a mobile device, in particular a smartphone or a wearable, preferably a smartwatch.

The fluid pressure can be an absolute pressure, preferably an ambient pressure of a sensor environment of the sensor element and/or a differential pressure, in particular between a front side and a rear side of the sensor element.

The sensor element can comprise at least one deflectable membrane. The membrane can be deflectable as a function of the fluid pressure. The measurement signal can depend on the deflection of the membrane. The sensor element can have a piezoresistive and/or capacitive measuring principle for measuring the deflection of the membrane. The sensor element can comprise a measuring bridge circuit for detecting a change in electrical resistance and/or a change in electrical capacitance when the membrane is deflected.

The measurement signal can be an analog and/or electrical signal.

“Acceleration cross-sensitivity” is the cross-sensitivity of the pressure sensor, in particular the sensor element, to accelerations. The measurement signal, which indicates the applied fluid pressure to the sensor element, can be influenced by accelerations because of the acceleration cross-sensitivity, thereby disturbing the pressure measurement. Acceleration cross-sensitivity can exist with respect to accelerations that include Earth's gravitational acceleration and/or an acting linear and/or rotational acceleration.

Acceleration cross-sensitivity can arise, depending on a mass of the protective mass, from an acceleration force acting on the sensor element, in particular on the membrane, as a function of the acceleration. The acceleration cross-sensitivity can, depending on the sensor area of the sensor element at which the acceleration force effectively acts, for example the membrane area of the membrane, correspond to an equivalent pressure that constitutes an acceleration-induced signal component (signal offset) in the measurement signal.

According to an example embodiment, the pressure sensor can be designed to be media-robust. The protective mass can separate, preferably seal, the sensor element from the sensor environment. The protective mass can be a protective gel and/or an oil, in particular a silicone oil or fluorinated oil. The protective mass can be viscoelastic and/or highly viscous. The protective mass can protect the sensor element from moisture, water, dirt and/or particles from the sensor environment. The protective mass can be made of an electrically insulating material. The protective mass can be arranged primarily, preferably exclusively, to protect the sensor element from environmental influences from the sensor environment. The protective mass can transfer the fluid pressure of the sensor environment to the sensor element. The sensor element can be accommodated by the protective mass in an airtight manner relative to the sensor environment. The protective mass can adjoin the sensor environment on a side opposite the sensor element. The protective mass can cover the entire sensor element.

The term “protective mass” can be understood as referring to a substance that protects against environmental influences, the mass of which exerts forces on the sensor element during acceleration and thus influences the acceleration cross-sensitivity. The protective mass can be designed in different ways, for example as a multi-layer protective layer, provided that it reliably transmits pressure and adequately protects the sensor element from environmental influences.

The pressure sensor can comprise a housing. The sensor element can be arranged in the housing. The protective mass can be arranged in the housing. The protective mass can extend up to a housing edge of the housing. The housing can comprise an opening facing the sensor environment of the pressure sensor for pressure transmission between the sensor environment of the pressure sensor and the sensor element.

The sensor element can be arranged on a support element, in particular a substrate. The housing can be arranged on the support element.

The heating device can be a device that introduces defined thermal energy into the protective mass. The heating device can use Peltier elements or inductive heaters. The heating device can deliver the required thermal energy in a controlled and as efficient a manner as possible. The heating device can be arranged in or on the sensor element, the housing and/or the support element. The heating device can convert electrical power into thermal power. The heating device can comprise at least one heating element, for example a heating resistor and/or a heating wire. The heating element can heat up when electric current is applied.

The temperature-measuring element can comprise a thermal-resistive measuring element, for example a PT100 or PT1000 resistor, and/or a thermoelectric measuring element. The temperature-measuring element can be arranged in or on the sensor element, the housing and/or the support element.

The pressure sensor can be connected to a control system for data transmission and/or energy transmission. The control system can control the operation of the pressure sensor. The control system can comprise a calculation unit for processing the measurement signals output by the pressure sensor.

The calculation of the parameter can be performed during the measurement operation or after the measurement operation. The parameter can be a mass of the protective mass. The parameter can depend on a mass m of the protective mass. The parameter can depend on a ratio of the mass to the membrane area. The mass m, with known specific heat capacity c of the material of the protective mass and a temperature difference ΔT between the temperature after introduction of the amount of thermal energy Q and the initial temperature, can be calculated as follows:

$$m = \frac{Q}{c Δ T}$$

The parameter P, as a function of a known membrane area A of the membrane of the sensor element and the mass m of the protective mass, can in particular be calculated as follows:

$$P = \frac{m}{A}$$

The measurement operation can be carried out in a state of the pressure sensor in which it is free of unknown and unwanted deposits, contamination and/or accumulations on the sensor element and/or the protective mass. The measurement operation can also be performed in the presence of unknown and unwanted deposits, contaminants and/or accumulations on the sensor element and/or the protective mass, and can thereby ascertain the parameter as an aggregate parameter consisting of the parameter of the protective mass and at least one parameter, for example a mass, of the unknown and unwanted deposits, contaminants and/or accumulations on the sensor element and/or the protective mass.

In a preferred example embodiment of the present disclosure, it is advantageous if the measurement operation is carried out during operation of the pressure sensor for measuring the fluid pressure. As a result, the parameter can be ascertained as needed. Even temporal changes in the parameter can be recorded. Operation of the pressure sensor can thus remain unimpaired.

In a special example embodiment of the present disclosure, it is advantageous if the pressure sensor comprises an electronics unit for processing the measurement signal and outputting the processed measurement signal. The electronics unit can comprise an analog-to-digital converter. The electronics unit can convert the measurement signal into a digital output signal. The electronics unit can be an ASIC. The electronics unit can comprise an integrated circuit and/or a microcontroller. The electronics unit can be arranged on the support element or form the support element. The heating device can be arranged in or on the electronics unit. The temperature-measuring element can be arranged in or on the electronics unit.

In a special example embodiment of the present disclosure, it is advantageous if the electronics unit controls the heating device for delivering the amount of thermal energy. The electronics unit can set (control or regulate) the heating output of the heating device for delivering the amount of thermal energy.

The heating output can be set over time as a ramp, in steps, or as a constant value. The heating output can be set while maintaining a desired time profile and/or a desired temperature profile.

A preferred example embodiment of the present disclosure is advantageous in which the measurement operation is triggered by a trigger event. As a result, measurement can be performed flexibly during operation or at specific times. The trigger event can be a trigger signal, a time, an environmental condition and/or a predetermined measurement parameter, for example a magnitude or a slope, of the measurement signal. The trigger signal can be generated by the pressure sensor and/or the control system.

In a special example embodiment of the present disclosure, it is advantageous if the parameter is stored in a retrievable manner. As a result, the parameter can be used and/or monitored for subsequent compensation, for example to detect a change. The parameter can be stored in a storage unit. The storage unit can be arranged in the pressure sensor or outside the pressure sensor. The storage unit can be arranged in the control system.

The parameter can alternatively or additionally be ascertained and/or verified by means of a further method, for example by acceleration measurement.

According to the present disclosure, a method for compensating for an acceleration cross-sensitivity of a pressure sensor is also provided.

In a preferred example embodiment of the present disclosure, it is advantageous if the compensation is carried out, in particular continuously, during operation of the pressure sensor for measuring the fluid pressure. As a result, the measurement signal can be corrected in real time for acceleration-induced interference components, and the fluid pressure can be detected more accurately. The pressure measurement of the fluid pressure can be more independent of acceleration influences.

In a preferred example embodiment of the present disclosure, it is advantageous if the pressure sensor comprises an acceleration-measuring element for measuring the acceleration value. The acceleration-measuring element can comprise an acceleration sensor. The acceleration-measuring element can be arranged in or on the support element.

In an advantageous example embodiment of the present disclosure, it is provided that the compensation value indicates a signal component in the measurement signal and a corrected measurement signal is output with the compensation. As a result, the measurement signal can be largely decoupled from acceleration influences. In particular, the continuous updating of the parameter during ongoing operation can bring about reliable compensation over the entire service life of the pressure sensor. The signal component in the measurement signal of the pressure sensor can correspond to an equivalent pressure. The equivalent pressure pₑ can, as a function of the parameter P and the acceleration value a, be calculated as follows:

$${p}_{e} = Pa$$

The compensation can subtract the equivalent pressure pₑ from the fluid pressure pₘ measured via the measurement signal and thereby output a corrected measured fluid pressure pc, in particular as follows:

$${p}_{c} = {p}_{m} - {p}_{e}$$

The method for ascertaining at least one parameter and/or the method for compensation can be carried out within the pressure sensor and/or within the pressure sensor and the control system.

The method for ascertaining at least one parameter and/or the method for compensation can be a computer-implemented method.

Furthermore, a computer program is provided that comprises machine-readable instructions executable on at least one computer, during the execution of which at least one of the above described methods is carried out.

Furthermore, a storage unit is provided, which is designed to be machine-readable and accessible by at least one computer and on which the aforementioned computer program is stored. The storage unit can be arranged in the pressure sensor.

Furthermore, the present disclosure relates to a pressure sensor as described above that is configured to perform the method for ascertaining at least one parameter and/or the method for compensation.

Further advantages and advantageous configurations of the present disclosure can be found in the description of the figures and in the FIGURE.

### BRIEF DESCRIPTION OF THE DRAWING

The FIGURE shows a method shows for compensation, a method for ascertaining at least one parameter, and a pressure sensor, according to example embodiments.

### DETAILED DESCRIPTION OF EXAMPLE EMBODIMENTS

The present disclosure is described in detail below with reference to the figure. The FIGURE shows a method for compensation, a method for ascertaining at least one parameter, and a pressure sensor, each in a specific embodiment of the present disclosure. The method for compensating for 10 an acceleration cross-sensitivity of a pressure sensor 12 comprises providing the pressure sensor 12 for measuring a fluid pressure 14, in particular in a sensor environment of the pressure sensor 12. The pressure sensor 12 comprises a sensor element 16 that provides a measurement signal 18 as a function of the fluid pressure 14 and has an acceleration cross-sensitivity with respect to an acceleration 20 acting on the pressure sensor 12. For example, the sensor element 16 comprises a membrane 22 that is deflected as a function of the fluid pressure 14, but can also be deflected when an acceleration 20 acts on the sensor element 16 and the membrane 22.

The pressure sensor 12 comprises, on the sensor element 16, a protective mass 24 to protect the sensor element 16 from environmental influences, said protective mass, however, causing (increasing) an acceleration cross-sensitivity of the sensor element 16 under the action of acceleration 20. The protective mass 24 can be a protective gel or an oil.

Furthermore, the pressure sensor 12 comprises a heating device 26 for delivering thermal energy. The heating device 26 can comprise a heating element that generates thermal energy through electrical energy.

Furthermore, the pressure sensor 12 comprises a temperature-measuring element 28 for measuring at least one temperature in the pressure sensor 12. The temperature-measuring element 28 can comprise a thermoelectric measuring element. The temperature-measuring element 28 can measure the temperature in the pressure sensor 12, particularly in the region of the protective mass 24, and record temperature measurement values T.

Furthermore, the pressure sensor 12 comprises an acceleration-measuring element 30 for measuring acceleration values a of the accelerations 20 acting on the pressure sensor 12. Here, the acceleration-measuring element 30 can measure the magnitude and direction of the acting accelerations 20.

Furthermore, the pressure sensor 12 comprises an electronics unit 34 for processing the measurement signal 18 and outputting the processed measurement signal. The electronics unit 34 can comprise an analog-to-digital converter and convert the measurement signal 18 into a digital output signal and is preferably an ASIC.

The method for compensation 10 furthermore comprises recording, by the acceleration-measuring element 30, of an acceleration value a of an acceleration 20 acting on the sensor element 16.

Furthermore, a compensation value of 36 is calculated as a function of a parameter P of the protective mass 24 and the acceleration value a. The parameter P indicates an influence of the protective mass 24 on the measurement signal 18 of the pressure sensor 12 under action of accelerations 20 and is retrievable for the compensation, for example stored in a memory unit 38. The parameter P was previously ascertained by a method for ascertaining 40 at least one parameter using a measurement operation 42, in particular a calibration operation.

The measurement operation 42 can be triggered by a trigger event 44, for example in a time-dependent manner, in particular at regular time intervals. The measurement operation 42 comprises inputting an amount of thermal energy Q at least into the protective mass 24 by operating the heating device 26 and measuring, by the temperature-measuring element 28, at least one temperature value T of the temperature that changes due to the amount of thermal energy Q. Then, the parameter P of the protective mass 24 is calculated 46 as a function of the amount of thermal energy Q and the temperature measurement value T. In particular, a temperature difference ΔT is calculated using the temperature measurement value T. Thus, the parameter P, with known specific heat capacity c of the material of the protective mass 24 and known membrane area A of the membrane 22, is calculated as follows:

$$P = \frac{Q}{cA Δ T}$$

The compensation value 36 can correspond to an equivalent pressure on the membrane 22 and be calculated as the product of the parameter and the recorded acceleration value a.

With this compensation value 36, a compensation 48 of the measurement signal 18 is performed during operation of the pressure sensor 12 for measuring the fluid pressure 14. The compensation value 36 can indicate, in particular, a signal component 50 in the measurement signal 18, in particular an acceleration-induced signal offset, which is subtracted from the measurement signal 18. The measurement signal 18′ corrected in this way is output.

What is claimed is:

1. A method for ascertaining a parameter of a protective mass of a pressure sensor configured to measure a fluid pressure, the method comprising the following steps:
providing the pressure sensor, including:
a sensor element that provides a measurement signal as a function of the fluid pressure and has an acceleration cross-sensitivity with respect to an acceleration acting on the pressure sensor,
the protective mass applied to the sensor element configured to protect the sensor element from environmental influences, the protective mass affecting the acceleration cross-sensitivity of the sensor element under an action of acceleration,
a heating device configured to deliver thermal energy, and
a temperature-measuring element configured to measure a temperature in the pressure sensor;
wherein in a measurement operation, the following steps are carried out:
inputting an amount of thermal energy at least into the protective mass by operating the heating device,
measuring, by the temperature-measuring element, at least one temperature measurement value of the temperature in the pressure sensor that changes due to the amount of thermal energy, and
after the measuring, calculating the parameter of the protective mass as a function of the amount of thermal energy and the at least one temperature measurement value.

2. The method er according to claim 1, wherein the measurement operation is carried out during operation of the pressure sensor for measuring the fluid pressure.

3. The method according to claim 1, wherein the pressure sensor includes an electronics unit configured to process the measurement signal and output the processed measurement signal.

4. The method according to claim 3, wherein the electronics unit controls the heating device for delivering the amount of thermal energy.

5. The method according to claim 1, wherein the measurement operation is triggered by a trigger event.

6. The method according to claim 1, wherein the parameter is stored in a retrievable manner.

7. A method for compensating for an acceleration cross-sensitivity of a pressure sensor for measuring a fluid pressure, comprising the following steps:
providing the pressure sensor, including:
a sensor element that provides a measurement signal as a function of the fluid pressure and has an acceleration cross-sensitivity with respect to an acceleration acting on the pressure sensor,
a protective mass applied to the sensor element configured to protect the sensor element from environmental influences, the protective mass affecting the acceleration cross-sensitivity of the sensor element under an action of acceleration,
a heating device configured to deliver thermal energy, and
a temperature-measuring element configured to measure a temperature in the pressure sensor,
wherein, in a compensation operation, the following steps are carried out:
recording an acceleration value of an acceleration acting on the sensor element,
retrieving a parameter of the protective mass calculated using a method for ascertaining a parameter of the protective mass, the method for ascertaining including:
inputting an amount of thermal energy at least into the protective mass by operating the heating device,
measuring, by the temperature-measuring element, at least one temperature measurement value of the temperature in the pressure sensor that changes due to the amount of thermal energy, and
after the measuring, calculating the parameter of the protective mass as a function of the amount of thermal energy and the at least one temperature measurement value,
calculating a compensation value as a function of the parameter and the acceleration value, and
compensating the measurement signal using the compensation value.

8. The method according to claim 7, wherein the compensation is carried out during operation of the pressure sensor for measuring the fluid pressure.

9. The method according to claim 7, wherein the pressure sensor includes an acceleration-measuring element configured to measure the acceleration value.

10. The method according to claim 7, wherein the compensation value indicates a signal component in the measurement signal and a corrected measurement signal is output with the compensation.
